(19) United States
(12) Patent Application Publication
(10) Pub. No.: US 2010/0004980 A1
(43) Pub. Date: Jan. 7, 2010

(54) SYSTEMS AND METHODS FOR MANAGING PRODUCT AND CONSUMER INFORMATION

(76) Inventor: Berkley Bowen, East Hampton, NY (US)

Correspondence Address: PATENT DOCKET ADMINISTRATOR;LOWENSTEIN SANDLER PC, 65 LIVINGSTON AVENUE, ROSELAND, NJ, 07068, US

(21) Appl. No.: 12/498,839

(22) Filed: Jul. 7, 2009

Related U.S. Application Data
(63) Continuation-in-part of application No. 11/625,686, filed on Jan. 22, 2007.
(60) Provisional application No. 61/164,828, filed on Mar. 30, 2009.
(60) Provisional application No. 60/760,551, filed on Jan. 20, 2006.

(51) Int. Cl. G06Q 30/00; H04W 4/12; G06F 3/048

(52) U.S. Cl. 705/10; 455/466; 705/14.25; 705/26; 715/760

(57) ABSTRACT

Systems and methods for processing, sharing, and tracking information related to products. The systems and methods allow consumers, by way of a centralized information hub, to search for information about products and share that information with other consumers across multiple communication channels by utilizing one or more of multiple technology platforms. The systems and methods also allow consumers to share information about themselves with retailers and vendors across multiple communication channels by utilizing one or more of multiple technology platforms. The systems and methods enable retailers and vendors to share product information, such as promotional information and discount information, to consumers across multiple communication channels by utilizing one or more of multiple technology platforms. Embodiments of the present invention allow users to search, access, view and share product-related information via standard text/SMS messaging in a device-agnostic manner.

### CROSS-REFERENCE TO RELATED APPLICATIONS

This application claims the benefit of U.S. Provisional Application 61/164,828 filed Mar. 30, 2009, which is hereby incorporated by reference herein in its entirety. This application is a continuation-in-part of U.S. patent application Ser. No. 11/625,686, filed Jan. 22, 2007, which claims the benefit of U.S. Provisional Application No. 60/760,551, filed Jan. 20, 2006. U.S. application Ser. Nos. 11/625,686 and 60/60,551 are hereby incorporated by reference herein.

### FIELD OF THE INVENTION

The present invention is generally related to systems and methods for processing information related to products, and more particularly, to the exchange of information among and between multiple vendors, retailers and consumers over multiple communication technology channels, including, for example, text and SMS communications channels.

### BACKGROUND OF THE INVENTION

The retail shopping business is presently undergoing radical change. Increased use of the Internet, wireless access, and the explosion of mobile devices are radically changing the retail shopping industry. Consumers now spend an increasing amount of their shopping time in the electronic world.

For consumers, the present market includes relatively disparate and unconnected shopping channels such as electronic commerce (e-commerce), mobile commerce (m-commerce) and bricks-and-mortar retail locations. Despite the evolution of technology and consumers' buying habits, however, there exists no completely satisfactory link for consumers between their online transactions and their offline purchases. Each of these shopping worlds is currently generally isolated for a consumer. This means that consumers, in the marketplace, who have demonstrated that they enjoy the convenience of shopping in an e-commerce environment, are still compelled to make transactions in a bricks-and-mortar world. Thus, a need exists to unite these disparate channels into a cohesive shopping experience, allowing consumers to manage their shopping experience across multiple channels, such as, bricks-and-mortar, e-commerce and m-commerce.

Additionally, as technology and consumer utilization continue to drive the adoption of e-commerce, retailers are being forced to adjust their abilities to satisfy their customers' needs. Successful retailers that operate in highly competitive markets are realizing that expenditures for technology and electronic marketing expertise are necessary. Retailers are under a driving trend to centralize their retail operations of both online and offline operations. Retailers who wish to be successful in the non-consumable goods (e.g., clothing) marketplace typically strive to utilize the time-tested techniques of discounting, quality product delivery, and superior customer service. In actuality, technology is enabling successful retailers to better meet the core needs of their consumers.

Retailers often create loyalty programs to retain their customers, capture a larger share of the consumers' purchases and obtain relevant demographic and purchasing history, to better target their promotional efforts. These loyalty programs have mostly taken the form of “card swipe” programs. Consumers are generally rewarded, at the time that a purchase is made, with discounts and incentives for purchases they make at the stores. Thus, retailers generally have relatively little or no information about a customer's product preferences (and thus, relatively little ability to influence the consumer) until the time that a purchase is made.

To keep up with current technological developments, many retailers and vendors have begun to invest in infrastructure that enable them to leverage these technical advances. However, conventional systems and methods do not take full advantage of potential beneficial links between the online and offline worlds, and, specifically, fail to provide a consumer with the ability to transmit a simple text and/or SMS message and instantly retrieve, search, or share information relating to products, promotions, retailers, or vendors associated with his or her wish list.

Thus, a need exits for multiple retailers and vendors to converge their bricks-and-mortar aspects with e-commerce and m-commerce initiatives and to leverage data across multiple channels for better marketing and merchandising operations. Furthermore, there is a need for systems and methods that provide a consumer/user with easy-to-use ‘on demand’ access via a keyword-driven text/SMS communications platform to product, promotion and vendor/retailer information associated with his or her wish list and/or a wish list maintained by one or more ‘friends’ associated with the consumer via a social networking web-based environment.

### SUMMARY OF THE INVENTION

Embodiments of the invention satisfy these and other needs by providing systems and methods for processing, sharing, and tracking information related to products. The systems and methods can allow consumers, by way of a centralized information hub, to search for information about products and share that information with other consumers across multiple communication channels by utilizing one or more of multiple technology platforms. The systems and methods can also allow consumers to share information about themselves with retailers and vendors across multiple communication channels by utilizing one or more of multiple technology platforms. The systems and methods can also allow retailers and vendors to share product information, such as promotional information and discount information, with consumers across multiple communication channels by utilizing one or more of multiple technology platforms. Embodiments of the systems and methods according to the present invention can also provide for a vendor/retailer-neutral hub and communication platform with consumers, such that no participating vendor/retailer is favored over another.

In some embodiments, consumers can search, identify and/or share information about products across a single, centralized network. The network is neutral as to products, vendors and retailers, and thus, can serve as a fair and beneficial gateway for sharing of information between consumers and vendors/retailers. Consumers can search for and identify products through multiple communication channels such as, for example, the Internet, bricks-and-mortar stores, television advertisements, newspapers and magazines, coupon books, billboards, as well as other forms of print and video advertisements.

According to embodiments of the present invention, users/consumers are provided with ‘on demand’ access to product, promotion and vendor/retailer information associated with his or her wish list via a keyword-driven text/SMS communications platform. Advantageously, the users/consumers may utilize his or her mobile device to transmit simple ‘keyword’-based commands and/or requests for wish list-related information via a standard text/SMS message, and receive the requested information via a return text/SMS message to his or her mobile device. In addition, the user/consumer may transmit a text/SMS message to initiate the execution of a requested action by the systems and methods according to embodiments of the present invention, including but not limited to, the ‘sharing’ of product, promotion, vendor, retailer, and/or wish list information with a second user. According to an embodiment of the present invention, the information being ‘shared’ by the first user with the second user may be communicated to the second user via a standard text/SMS message transmitted to the second user's mobile device. In addition, the first user may select the format and/or method of communication with the second user. For example, the first user can direct the ‘shared’ communication to be via an electronic mail message, an SMS message, or a Facebook entry/posting.

According to an embodiment of the present invention, the systems and methods provide a powerful socially interactive shopping utility that allows a retailer's customers to bookmark any product and add it to his or her wish list. In addition, the systems and methods allow a user/consumer to comment on a product, retailer, and/or vendor and share his or her comment with the user's friends and/or social networks, thus sharing the user's ‘instant feedback’ concerning a product, retailer, and/or vendor. Advantageously, the systems and methods may be utilized by any suitable mobile device, and are protocol and device agnostic, allowing a user with flexibility to use a desktop or mobile computing device to access the systems and methods of the present invention in any product research, shopping, and purchasing scenario (e.g., while shopping online, while reading a print or outdoor ad, or while shopping in a brick-and-mortar store).

According to embodiments of the present invention, a user/consumer can ‘pull’ or retrieve his or her multi-channel-based wish lists on-demand from any device and from any location. Advantageously, the systems and methods of the present invention allow the user to engage in a direct personalized conversation with a retailer or vendor regarding the products and/or promotions he or she is interested in, thereby enabling the retailer/vendor to deliver user-targeted, real-time, and/or location-appropriate product-based promotions.

### BRIEF DESCRIPTION OF THE DRAWINGS

FIG. 1a is an exemplary schematic diagram illustrating a system for managing product and purchase information, in accordance with embodiments of the invention;

FIG. 1b is an exemplary schematic diagram illustrating a system for managing product and purchase information, in accordance with embodiments of the invention;

FIG. 2 is an exemplary flow diagram illustrating a method of managing product and purchase information, in accordance with embodiments of the invention;

FIG. 3 is an exemplary flow diagram illustrating a method of managing product and purchase information, in accordance with embodiments of the invention;

FIG. 4 is an exemplary flow diagram illustrating a method of managing product and purchase information, in accordance with embodiments of the invention;

FIG. 5 is an exemplary flow diagram illustrating a method of managing product and purchase information, in accordance with embodiments of the invention;

FIG. 6 is an exemplary flow diagram illustrating a method of managing product and purchase information, in accordance with embodiments of the invention;

FIG. 7 is an exemplary flow diagram illustrating a method of managing product and purchase information, in accordance with embodiments of the invention;

FIG. 8 is an exemplary flow diagram illustrating a method of managing product and purchase information, in accordance with embodiments of the invention;

FIG. 9 is an exemplary flow diagram illustrating a method of managing product and purchase information, in accordance with embodiments of the invention;

FIG. 10 is an exemplary flow diagram illustrating a method of managing product and purchase information, in accordance with embodiments of the invention;

FIG. 11 is an exemplary schematic diagram illustrating paths of information flow for a system for managing product and purchase information, in accordance with embodiments of the invention;

FIG. 12 illustrates an exemplary process flow for providing on-demand delivery of product-related information, in accordance with embodiments of the present invention; and

FIG. 13 presents a list of exemplary commands for use in accordance with the SMS On-Demand System, in accordance with embodiments of the present invention.

### DETAILED DESCRIPTION OF THE INVENTION

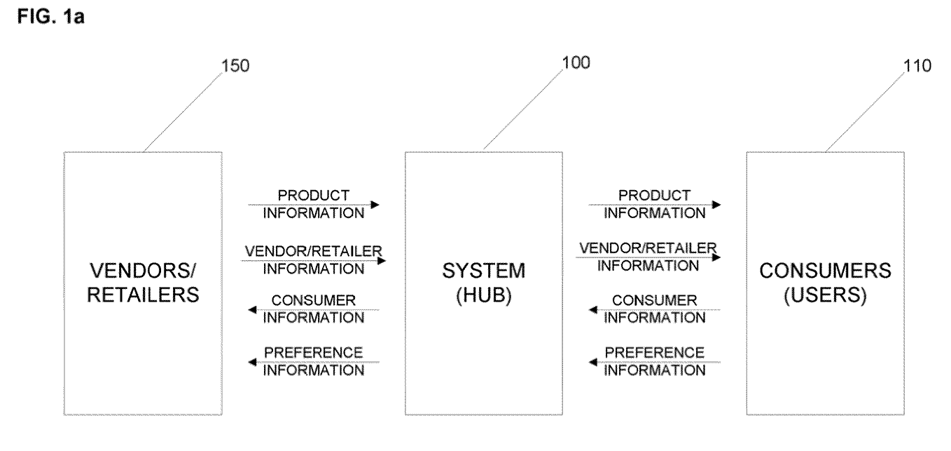

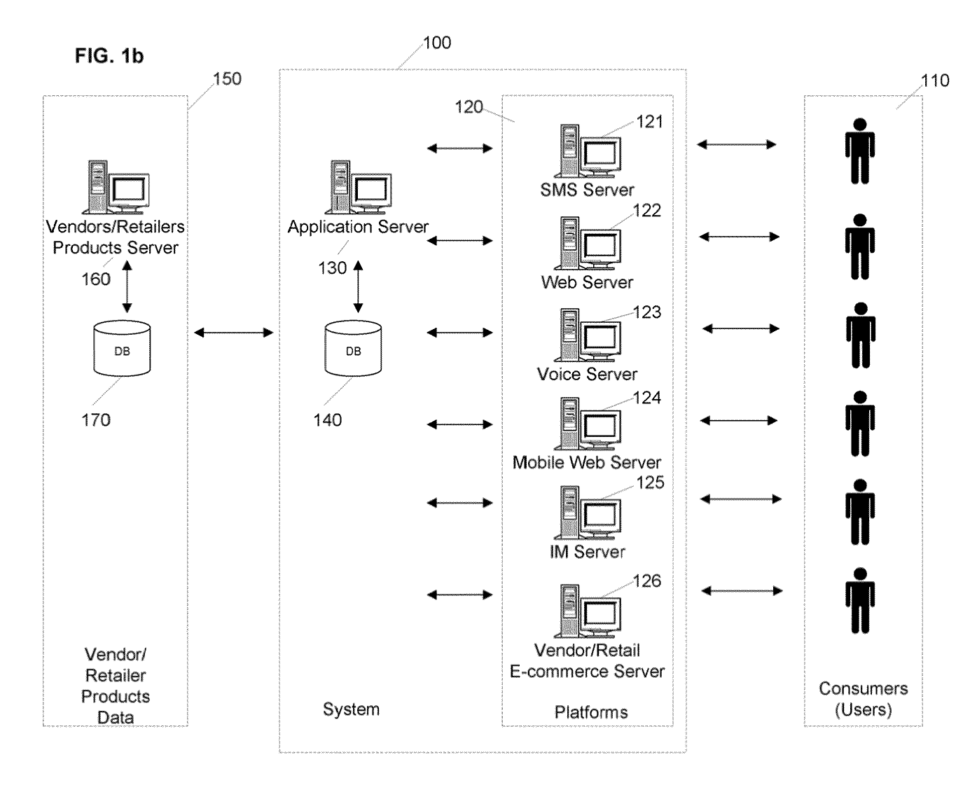

With reference to FIG. 1a, an overview of a system for managing product and purchase information 100 (herein referred to as the “system”), in accordance with embodiments of the invention, is shown. As is described in further detail below, consumers (also referred to as “users”) 110 can communicate and share information about themselves and product preferences with the system. Similarly, vendors and retailers 150 can share information about products with and via the system 100.

The system 100 serves as a neutral hub or network over which consumers 110 and vendors/retailers 150 can share and exchange information. The system provides access to multiple vendors/retailers 150, and multiple consumers 110, and can be vendor/retailer and product neutral, and thus, does not favor any one vendor/retailer over another.

Consumers can share information over multiple different communication platforms, such as, for example, Short Message Service (SMS), the Internet, including the Web, voice, mobile communications, and Instant Messaging (IM), as well as other communication technologies, as now known, or later developed. Consumers 110 can, for example, enter identification, demographic, and product information, via the Web, and then receive product information via an SMS message at a cell phone.

Consumers 110 can share with the system 110 information related to their identification, demographic information, and product preference information. Identification and/or demographic information can include name and address information, age, gender, social activity preferences, and hobbies, as well as other related information, as is known to those of skill in the art. Portions of this consumer information can be share with other consumers 110, via Affinity (or shared social network) groups. Portions of this consumer information can also be shared with vendors and retailers 150.

According to an embodiment of the present invention, a consumer 110 may create and authorize an association with one or more other consumers (i.e., ‘friends’), thereby resulting in a ‘friend list’ which is recognized by the system 100. A consumer 110 may receive from the system 100, information about product preference(s) and demographic information related to another consumer 110 with which they are associated (i.e., a friend), as well as product and vendor/retailer information from vendor/retailers 150. This information from the vendor/retailers 150 can include coupons and/or product promotion information.

Vendors/retailers 150 can share with the system 100 information related to products, such as pricing, inventories, delivery times, etc. Vendors/retailers can also share information related to the vendors/retailers 150 themselves, such as store locations, office hours, etc. Vendors/retailers can receive from the system information related to consumers 110 such as portions of identification information, demographic information and product preference information. Vendors/retailers can use the consumer information to plan inventories, production runs, product promotions, and to target specific consumers 10 for certain promotions.

With reference to FIG. 1b, the system for managing product and purchase information 100, is shown in greater detail. By way of some embodiments, users 110, or consumers, can send and receive information via an application server 130, to be stored and searched from a database 140. Users 110 can send and receive information to the application server 130 via multiple communication technology platforms 120, such as, by way of non-limiting example, Short Message Service (SMS) server 121, Web server 122, Voice server 123, Mobile Web server 124, and Instant Messenger (IM) server 125. Users 110 can also communicate with Vendor/Retailer e-commerce server 126. In some embodiments, a user 110 can first communicate with a Vendor/Retail e-commerce server 126, and be channeled to application server 130. Alternatively, in certain circumstances, as is discussed in further detail below, a user 110 can first communicate with application server 130, and then be subsequently directed to Vendor/Retail server 125. Alternatively, a client-side application, programmed and configured in conjunction with the system 100, can reside on a vendor/retailer e-commerce server 126, to provide for portions of the functionality described herein, from the vendor/retailer e-commerce server 126 platform. In such embodiments, the client-side application can be in networked communication with the system 100, as is known to those skilled in the art.

The multiple communication technology platforms 120 can be utilized by multiple users 110 to communicate with the application server 130 and database 140, Vendor/Retail e-commerce servers 126, and other users 110.

Vendors and/or retailers 150 can share product and vendor/retailer information (such as, for example, pricing and inventory information, as well as other related information), stored at vendor/retailer database 170 and managed by vendor/retailer products server 160, with the system 100. Vendors/retailers 150 can also receive information about consumers 110 and related product preference information from the system 100.

Thus, by way of some embodiments, multiple communication technology platforms 120 serve as media for the exchange of information between consumers, retailers and manufacturers, as is described in greater detail below.

In some embodiments, multiple consumers (users) 110, retailers and vendors can register at the application server 130 via, for example, Web server 122. The consumer registration includes accessing a Web page, and creating a profile for each individual user 110 at the application server 130. The profile, also referred to as a user profile or user account, may include, but is not limited to, a user's name, contact information, credit card number, a ‘user wishlist’, a list of other users authorized to share information referred to as a ‘friend’ list, also referred to herein as an ‘Affinity Group’, access to all or a portion of one or more wishlists associated with a friend or Affinity Group in accordance with permissions defining the level and scope of access as established by the users via the system 100, as well as others. The user/consumer registration can also include assignment of devices and linking of loyalty programs for each individual user. As used herein, the term “wishlist” is intended to include a compilation of product-related information identified by a user and stored in a user profile.

According to an embodiment of the present invention, each retailer/vendor using the system 100 is registered, whereby one or more individual store level profiles and an associated corporate level profile are created and stored at the application server 130.

From the user (consumer) 110 perspective, a user 110 can create a shopping list including all the merchandise items selected by the user 110. The user 110 can retrieve the shopping list via one or more of the multiple communication technology platforms 120.

From the retail perspective, the application server 140 can facilitate uploading of product assortments, catalogs, associated bar codes or Universal Product Codes (UPCs), uploading of promotions, and uploading of required loyalty program information. The application server 130 can also serve to integrate the Web server 122 used by the consumer to a Vendor/Retail e-commerce server 126 utilized by a vendor or retailer so that a consumer can add vendor and/or retail products to his or her shopping list. In addition, in some embodiments, application server 130 can upload advertising information and targeted advertising packages from vendors/retailers.

One or more users 110 can enter the application server 130 via one or more of the Web servers 122, and select one or more merchandise items from the product assortments provided by the vendor/retailer 150. A shopping list can be created for each of the users 110 who use the system 100. A shopping list can be exclusively owned, organized and managed by the user 110. A user 110 can authorize other users 110 (i.e., friends) to access or view all or a select portion of his or her shopping or product list. The product list or wishlist, includes items that a user wishes to purchase, and/or has purchased in the past. In some embodiments, such a shopping list can be selectively made accessible to certain merchants and manufacturers to enable the merchants and manufacturers to observe the purchasing activity and/or desires of the user 110 that relate to that specific merchant/manufacturer. Thus, by way of embodiments of the invention, vendors and retailers are provided with an opportunity to communicate with users (consumers) 110 prior to the users 110 making a purchase of the items. Consequently, by way of some embodiments, vendors and retailers 150 can target consumers 110 in a pre-purchase environment, to identify the consumers' needs, likes and dislikes, and shopping habits, as well as other preferences and information related to the users 110.

As discussed above, embodiments of the invention can provide certain benefits to the user (consumer) 110. One such benefit is that users 110 can input and retrieve relevant product and personal information when, from where; and in the manner that they want. Users 110 can also optimize purchasing power and the convenience of the shopping experience. By way of some embodiments, users can create a community (Affinity Group) around the users' 110 purchasing wants and needs.

In addition, embodiments of the invention can provide benefits to retailers/vendors. Such benefits can include allowing vendors/retailers to obtain pre-purchase consumer intelligence, leverage “venues” more effectively, enhance target promotions and virally expand their customer base through voluntary sharing of users' 110 consumer information (creation of community). Such features can provide for increased sales, profits and margin for retailers/vendors and provide cross-channel efficiencies (economies of scale).

While embodiments of system 100 are described herein as including certain distinct servers and/or hardware components for providing certain distinct functions, such description is made for ease of understanding. Accordingly, functions described herein as being performed by multiple servers and/or components and/or databases could be performed by a single server, component and/or database, and likewise, functions described herein as being performed by a single server, component and/or database could be performed by multiple servers, components, and/or databases, as would be understood by one of skill in the art, as instructed by the present disclosure. In addition, while servers are described herein as performing the various functions of system 100, system 100 could be implemented by other combinations of hardware and software sub-systems as would be understood by one of skill in the art, as instructed by the present disclosure.

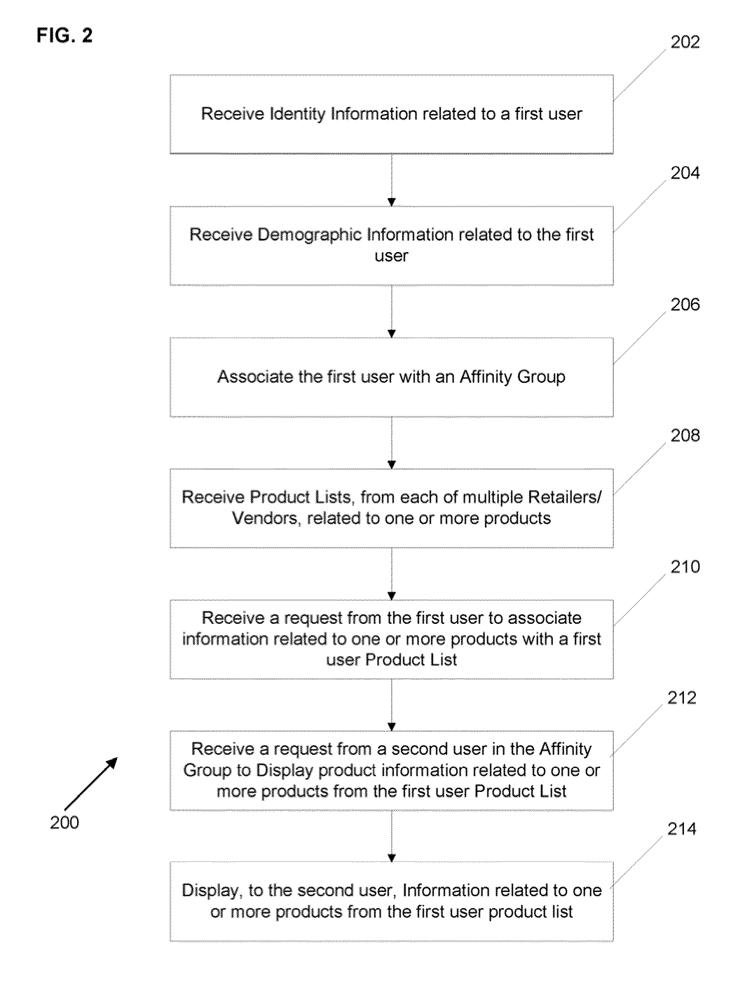

With reference to FIG. 2, there is shown a method 200 of managing product and purchase information, in accordance with embodiments of the invention. The method allows a first user to create a preferred product list, containing products that the first user wishes to acquire. A second user, who is a member of the first user's Affinity Group or friend list, can access the first user's product list in accordance with the level and scope of access granted to him or her by the first user. In step 202, the system 100 receives identity information related to a first user. In step 204, the system receives demographic information related to the first user. Pursuant to an instruction from the first user, the system 100 associates the first user with an Affinity Group or one or more friends, in step 206. In step 208, the system receives product lists, from each of multiple retailers/vendors, related to one or more products. The system receives a request from the first user to associate information related to one or more products with a first user product list, in step 210. In step 212, the system receives a request from a second user in the Affinity Group to display product information related to one or more products from the first user product list. In step 214, the system displays, to the second user, information related to one or more products from the first user product list, in accordance with the level and scope of access granted to the second user by the first user.

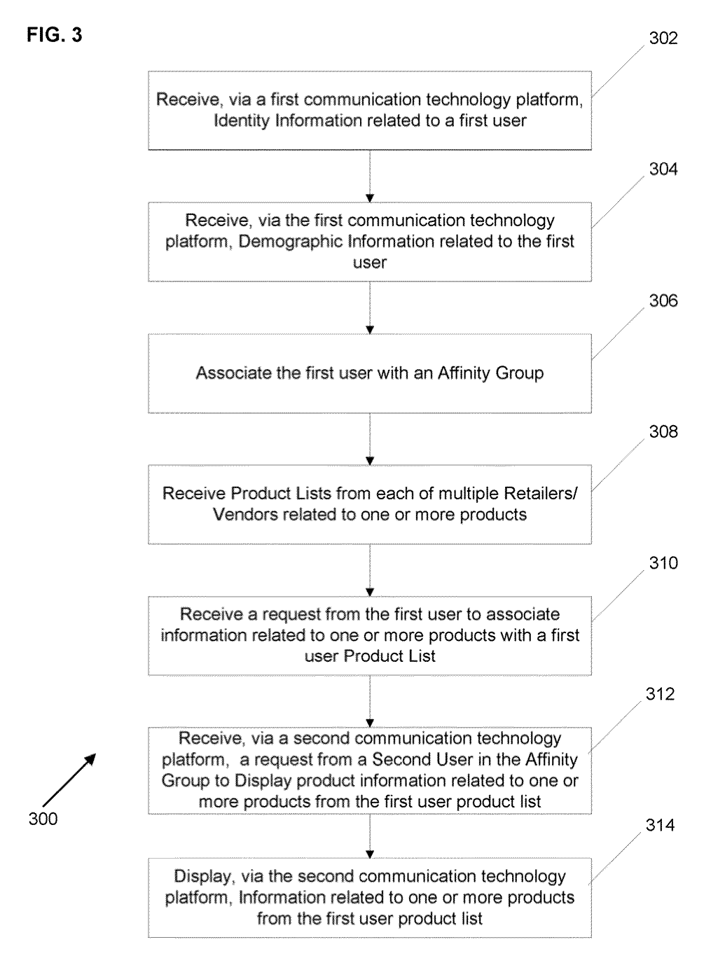

With reference to FIG. 3, there is shown a method 300 of managing product and purchase information, in accordance with embodiments of the invention. The method allows a first user to enter identification data and demographic data, as well as create a preferred product list, via a first communication technology platform, containing products that the first user wishes to acquire. The communication technology platform can include SMS (text), the Web, the Internet, voice, mobile, and IM, as well as other communication technologies, as now known, or later developed. A second user, who is a member of the first user's Affinity Group, can access the first user's product list, via a second communication technology platform. According to embodiments of the present invention, the first communication technology platform may be the same as the second communication technology platform (e.g., wherein both the first and the second communication technology platforms comprise the SMS Server-based platform) or different from the second communication technology platform (i.e., wherein the first communication technology platform comprises the SMS Server-based platform and the second communication technology platform comprises the Web Server-based platform). In step 302, the system receives, via a first communication technology platform, identity information related to a first user. In step 304, the system receives, via the first communication technology platform, demographic information related to the first user. The system associates the first user with an Affinity Group pursuant to an instruction from the first user, in step 360. In step 308, the system receives product lists from each of multiple retailers/vendors related to one or more products. In step 310, the system receives a request from the first user to associate information related to one or more products with a first user product list. In step 312, the system receives, via a second communication technology platform, a request, from a second user in the Affinity Group, to display product information related to one or more products from the first user product list (i.e., a product wish list associated with the first user). In step 314, the system displays, via the second communication technology platform, information related to one or more products from the first user product list.

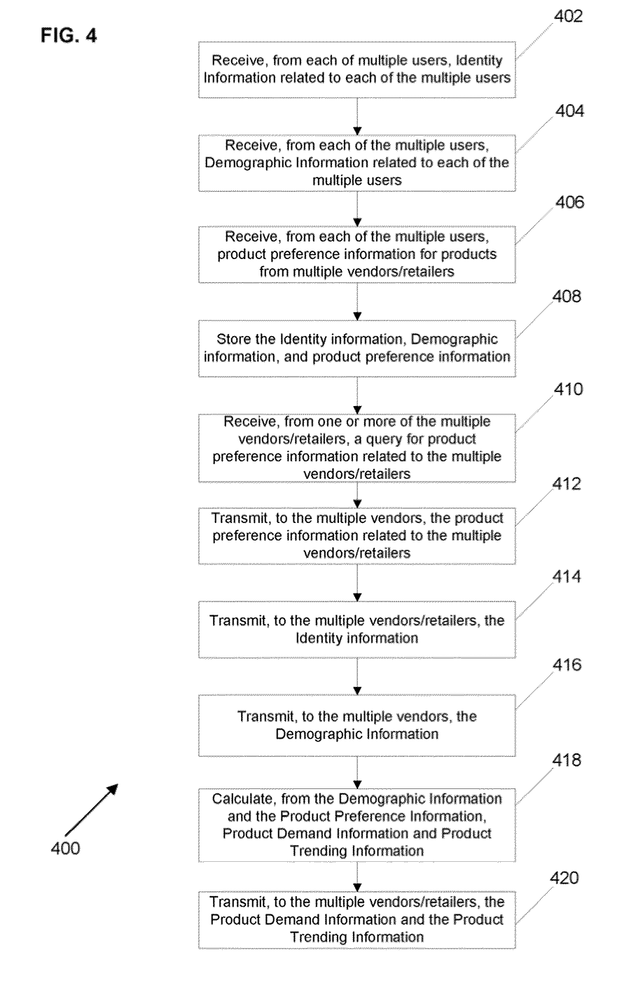

With reference to FIG. 4, there is shown a method 400 of managing product and purchase information, in accordance with embodiments of the invention. The method allows vendors/retailers to receive information about consumers, including demographic information and product preference information. In step 402, the system receives, from each of multiple users, identity information related to each of the multiple users. In step 404, the system receives, from each of the multiple users, demographic information related to each of the multiple users. The system receives, from each of the multiple users, product preference information for products from multiple vendors/retailers, in step 406. In step 408, the system stores the identity information, demographic information, and product preference information. In step 410, the system receives, from one or more of the multiple vendors/retailers, a query for product preference information related to the multiple vendors/retailers. In step 412, the system transmits, to the multiple vendors/retailers, the product preference information related to the multiple vendors/retailers. The system transmits, to the multiple vendors/retailers, the identity information, in step 414. In step 416, the system transmits, to the multiple-vendors, the demographic information. In step 418, the system determines, from the demographic information and the product preference information, product demand information and/or product trending information. In step 420, the system transmits, to the multiple vendors/retailers, the product demand information and/or the product trending information.

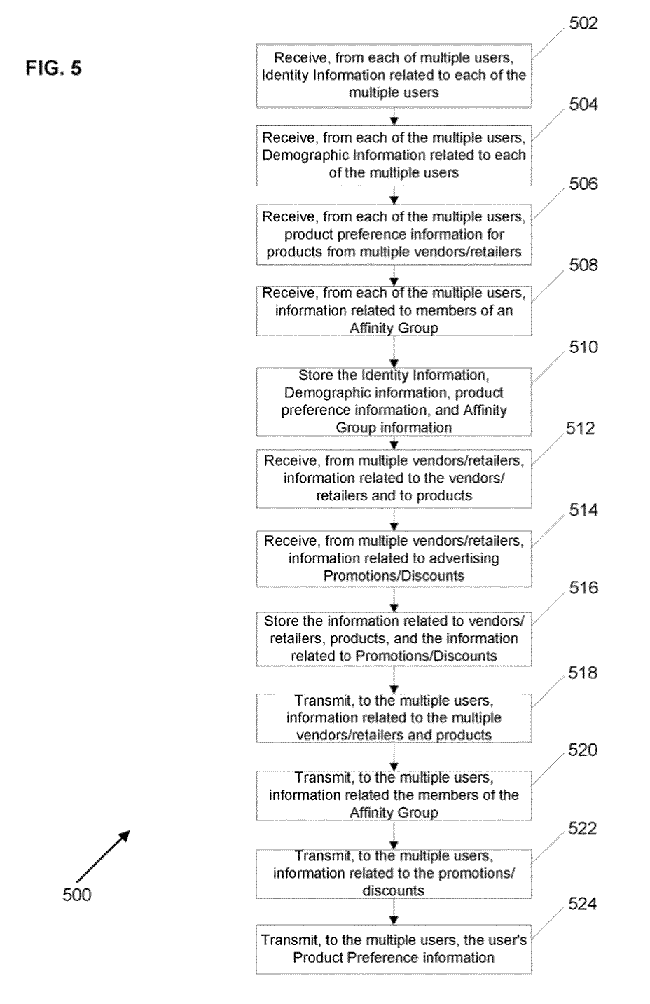

With reference to FIG. 5, there is shown, a method 500 of managing product and purchase information, in accordance with embodiments of the invention. The method allows consumers to receive information related to members of an Affinity Group, as well as information related to promotions and discounts. In step 502, the system receives, from each of multiple users, identity information related to each of the multiple users. In step 504, the system receives, from each of the multiple users, demographic information related to each of the multiple users. In step 506, the system receives, from each of the multiple users, product preference information for products from multiple vendors/retailers. In step 508, the system receives, from each of the multiple users, information related to members of an Affinity Group. In step 510, the system stores the identity information, demographic information, product preference information, and Affinity Group information. In step 512, the system receives, from multiple vendors/retailers, information related to the vendors/retailers and to their products. In step 514, the system receives, from multiple vendors/retailers, information related to advertising promotions/discounts. In step 516, the system stores the information related to vendors/retailers, products, and the information related to promotions/discounts. In step 518, the system transmits, to the multiple users, information related to the multiple vendors/retailers and products. In step 520, the system transmits, to the multiple users, information related the members of the Affinity Group (e.g., user comments and/or product data). In step 522, the system transmits, to the multiple users, information related to the promotions/discounts. In step 524, the system transmits, to the multiple users, each of the users' product preference information.

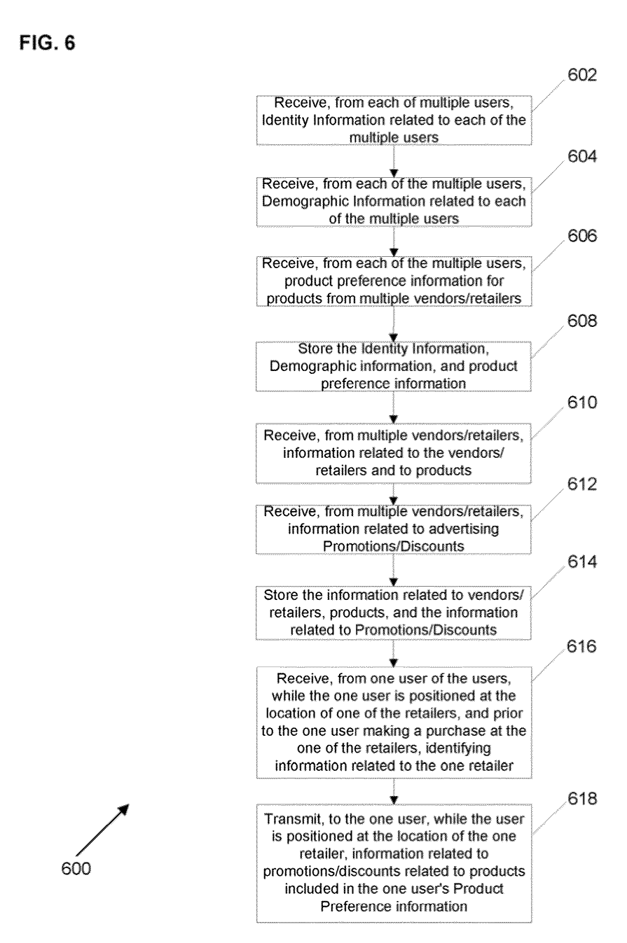

With reference to FIG. 6, there is shown a method 600 of managing product and purchase information, in accordance with embodiments of the invention. The method provides for a vendor/retailer to identify a consumer, and the consumer's product preferences, before any purchase is made by the consumer, as the consumer enters the vendor/retailer location. In step 602, the system receives, from each of multiple users, identity information related to each of the multiple users. In step 604, the system receives, from each of the multiple users, demographic information related to each of the multiple users. In step 606, the system receives, from each of the multiple users, product preference information for products from multiple vendors/retailers. In step 608, the system stores the identity information, demographic information, and product preference information. In step 610, the system receives, from multiple vendors/retailers, information related to the vendors/retailers and to products. In step 612, the system receives, from multiple vendors/retailers, information related to advertising promotions/discounts. In step 614, the system stores the information related to vendors/retailers, products, and the information related to promotions/discounts. In step 616, the system receives, from one user of the users, while the one user is positioned at the location of one of the retailers, and prior to the one user making a purchase at the one of the retailers, identifying information related to the one retailer. In step 618, the system transmits, to the one user, while the user is positioned at the location of the one retailer, information related to promotions/discounts related to products included in the one user's product preference information.

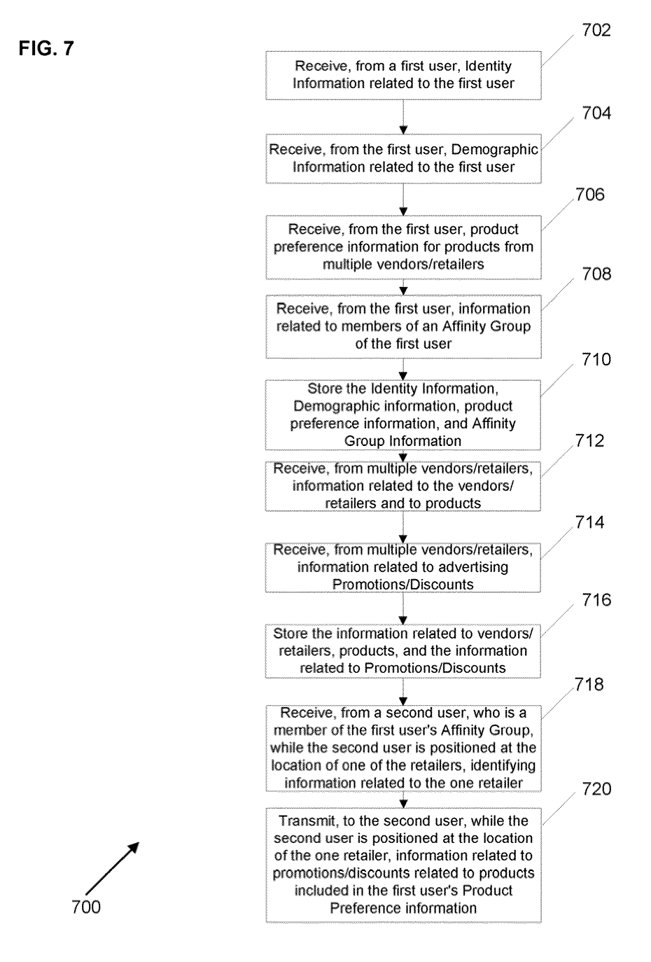

With reference to FIG. 7, there is shown a method 700 of managing product and purchase information, in accordance with embodiments of the invention. The method provides for a vendor/retailer to identify a first consumer, and the first consumer's product preferences, before any purchase is made by a second consumer (e.g., a friend or family member of the first user, who is a member of the first user's Affinity Group), as the second consumer enters the vendor/retailer location (with the intention of purchasing a product for the first consumer). In step 702, the system receives, from a first user, identity information related to the first user. In step 704, the system receives, from the first user, demographic information related to the first user. In step 706, the system receives, from the first user, product preference information for products from multiple vendors/retailers. In step 708, the system receives, from the first user, information related to members of an Affinity Group of the first user. The system stores the identity information, demographic information, product preference information, and Affinity Group information, in step 710. In step 712, the system receives, from multiple vendors/retailers, information related to the vendors/retailers and to products. In step 714, the system receives, from multiple vendors/retailers, information related to advertising promotions/discounts. In step 716, the system stores the information related to vendors/retailers, products, and the information related to promotions/discounts. In step 718, the system receives, from a second user, who is a member of the first user's Affinity Group, while the second user is positioned at the location of one of the retailers, identifying information related to the one retailer. In step 720, the system transmits, to the second user, while the second user is positioned at the location of the one retailer, information related to promotions/discounts related to products included in the first user's product preference information.

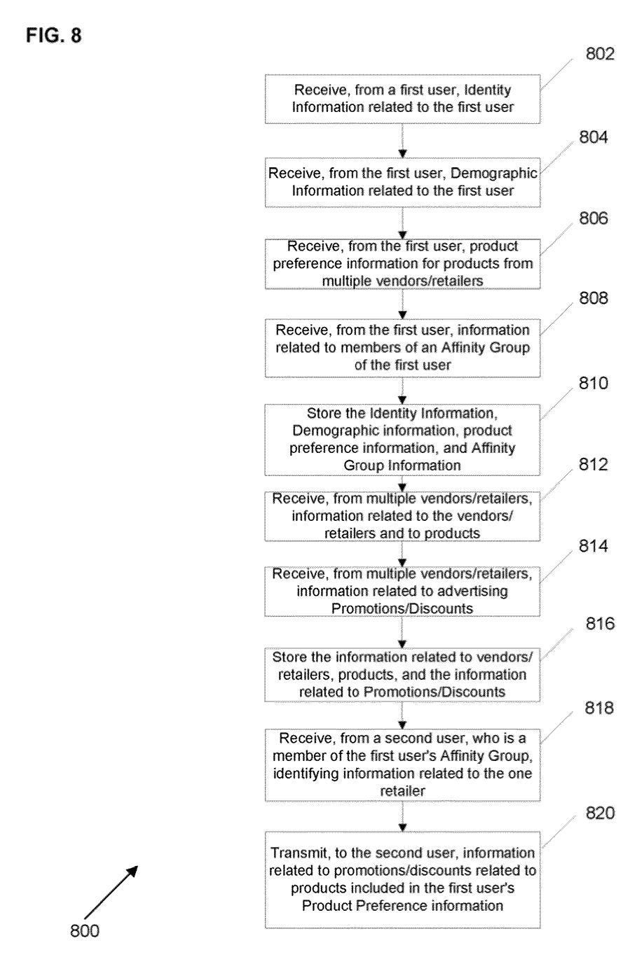

With reference to FIG. 8, there is shown a method 800 of managing product and purchase information, in accordance with embodiments of the invention. The method provides for a vendor/retailer to identify a first consumer, and the first consumer's product preferences, before any purchase is made by a second consumer, as the second consumer (i.e., a friend of the first consumer who is previously authorized via the system to view all or a portion of the first consumer's product-related information) views product-related information associated with the first consumer (e.g., information relating to the first consumer's product preferences), in accordance with permissions and levels of access as determined and granted by the first consumer. According to an embodiment of the present invention, the first consumer may define the scope and level of access granted to the second consumer by initiating a ‘share’ of particular product-related information with the second consumer, as described in detail below. In step 802, the system receives, from a first user, identity information related to the first user. In step 804, the system receives, from the first user, demographic information related to the first user. In step 806, the system receives, from the first user, product preference information for products from multiple vendors/retailers. In step 808, the system receives, from the first user, information related to members of an Affinity Group of the first user. The system stores the Identity Information, Demographic information, product preference information, and Affinity Group Information, in step 810. In step 812, the system receives, from multiple vendors/retailers, information related to the vendors/retailers and to products. In step 814, the system receives, from multiple vendors/retailers, information related to advertising promotions/discounts. In step 816, the system stores the information related to vendors/retailers, products, and the information related to Promotions/Discounts. In step 818, the system receives, from a second user, who is a member of the first user's Affinity Group, identifying information related to the one retailer. In step 820, the system transmits, to the second user, information related to promotions/discounts related to products included in the first user's Product Preference information.

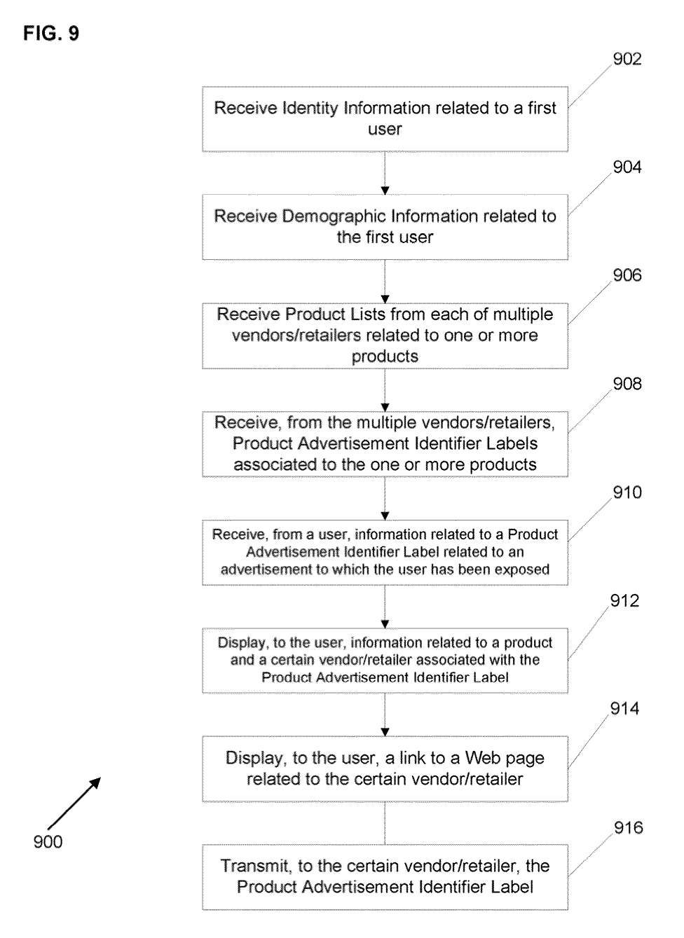

With reference to FIG. 9, there is shown a method 900 of managing product and purchase information, in accordance with embodiments of the invention. The method allows a vendor/retailer to place a product advertisement identifier label (also referred to as an “IMI identifier”) in an advertisement. When a consumer enters the label into the system, he is she is directed to the Web site of the vendor/retailer. In step 902, the system receives identity information related to a first user. In step 904, the system receives demographic information related to the first user. In step 906, the system receives product lists from each of multiple vendors/retailers related to one or more products. In step 908, the system receives, from the multiple vendors/retailers, product advertisement identifier labels associated to the one or more products. In step 910, the system receives, from a user, information related to a product advertisement identifier label related to an advertisement to which the user has been exposed. In step 912, the system displays, to the user, information related to a product and a certain vendor/retailer associated with the product advertisement identifier label. In step 914, the system displays, to the user, a link to a Web page related to the certain vendor/retailer. In step 916, the system transmits, to the certain vendor/retailer, the product advertisement identifier label. Thus, when a consumer views an advertisement, having a product advertisement identifier label, and the label is entered into the system, the consumer can be directed to the Web site of the vendor/retailer that sponsored the advertisement, thus promoting channel integrity. The vendor/retailer can then keep of track of the various traffic levels generated by different advertising channels, and use the information for strategically planning advertising purchases in the future.

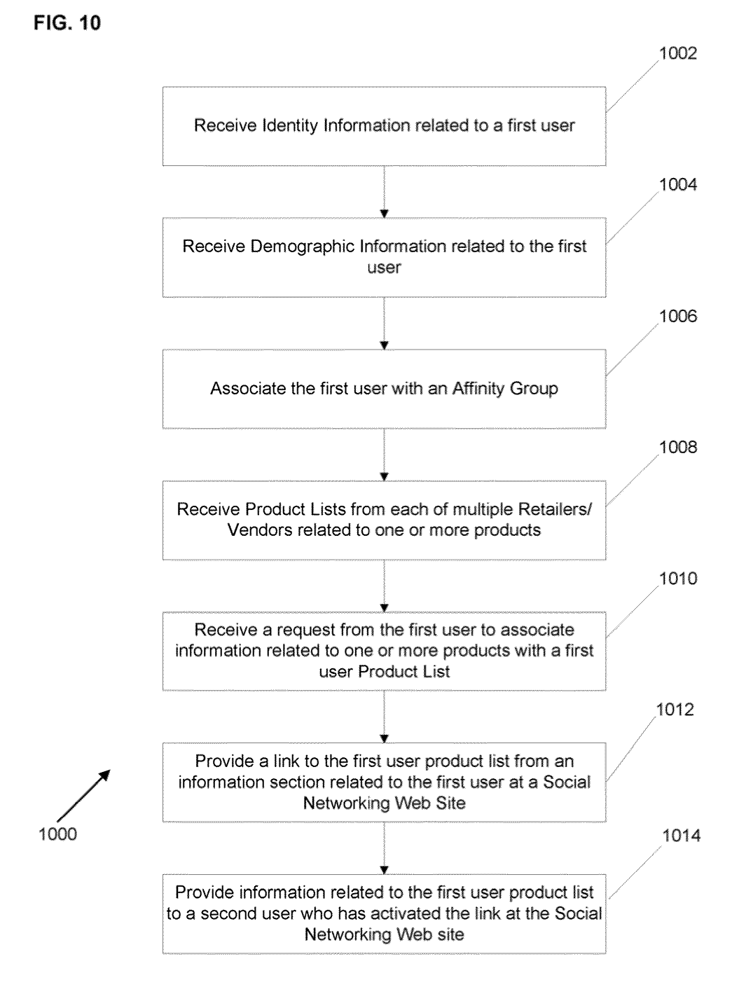

With reference to FIG. 10, there is shown a method 1000 of managing product and purchase information, in accordance with embodiments of the invention. The method allows a consumer to associate a link with a section of a social networking Web site. When other users of the Web site review the consumer's section (personal page) of the Web site, they can click on the link and be directed to a Web page of the system, so that the users can learn about the purchasing preferences of the consumer. In step 1002, the system receives identity information related to a first user. In step 1004, the system receives demographic information related to the first user. In response to a request from the first user, in step 1006, the system associates the first user with an Affinity Group. In step 1008, the system receives product lists from each of multiple retailers/vendors related to one or more products. In step 1010, the system receives a request from the first user to associate information related to one or more products with a first user Product List. In step 1012, the system provides a link to the first user product list from an information section related to the first user at a Social Networking Web Site, such as, for example, MySpace.com. The system provides information related to the first user product list to a second user who has activated the link at the Social Networking Web site, in step 1014.

While embodiments of the invention are described herein as including certain steps, performed in a certain order, alternate embodiments of the invention can include the steps, performed in a different order, and/or with certain steps being performed more than one time. Also, embodiments can include fewer than all of the steps, and/or additional steps.

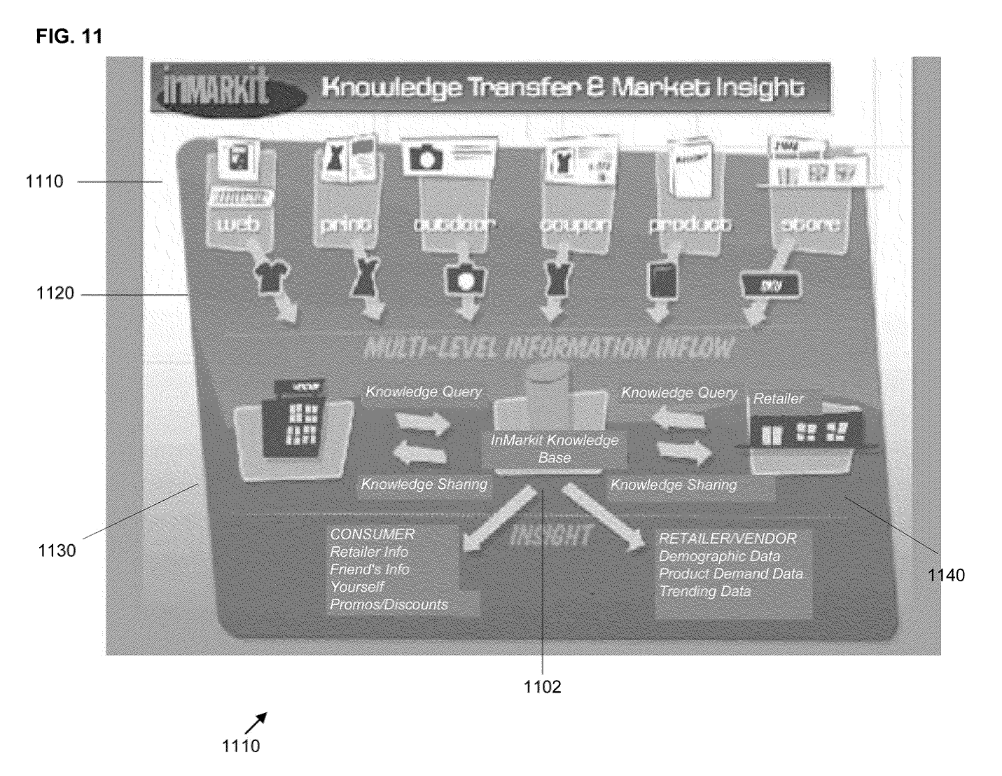

With reference to FIG. 11, there is shown various paths of information flow for a system 1100, in accordance with embodiments of the invention. The information flow paths facilitated by some embodiments can facilitate beneficial knowledge transfer and market insights. By way of some embodiments, users (consumers) 110 (see FIG. 1) can receive information about (or learn about) products from various channels 1110, such as the Internet, print advertisements, outdoor billboards, coupon books, actual product packaging, and information from bricks-and-mortar stores. In some embodiments, Product Advertisement Identifier Labels can be associated with some advertised products. For example, a Product Advertisement Identifier Label can be an alphanumeric code displayed on, for example, a billboard advertisement. The Product Advertisement Identifier Label can be noted by the user 110 when viewing the advertisement, and sent to the knowledge base 1102 where it can be stored, and associated with the advertised product, and/or the retailer that sponsored the advertisement, and the user 110.

As described above, users 110 can communicate information related to the advertised products, as well as identification, demographic, and product preference information to the centralized knowledge base 1102 via multiple communication technology platforms 1120, such as SMS, the Internet, voice communications, mobile communications, and IM communications.

By way of Affinity Groups, users 110 can share with other users 110 user identification information, demographic information, and product preference information, as well as other types of information. Users 110 can also share information with vendors 1130 and retailers 1140. By way of such knowledge sharing, vendors 1130 and retailers 1140 can benefit from information such as, for example, information related to potential customer demographic data, future product demand data and potential purchaser trending data. Users (consumers) 110 can also benefit from such knowledge sharing by information related to, for example, the product preferences of friends within an Affinity Group, information related to the user's 110 previously recorded product preferences, information about products and pricing offered at retailers, and coupons and promotional information offered by the retailers and vendors.

Thus, embodiments provide retailers and vendors with the ability to engage in a pre-sale dialogue with consumers that includes, but is not limited to the delivery of targeted promotions tied to the consumers' shopping lists and other criteria, as well as the ability to query aggregate consumer data.

Some embodiments serve to unite multiple communication platforms into a cohesive network, enhancing the consumer shopping experience through the seamless integration of the bricks-and-mortar, e-commerce, and m-commerce retail channels. The system can be a unique medium for the exchange of information between consumers, retailers, and vendors. The ability to engage consumers in a pre-sale dialogue, tailored to their voluntarily expressed shopping needs, represents a paradigm shift in targeted promotion and consumer intelligence.

The system can act as a single-platform information-based software program that connects customers, retailers and vendors. It can allow for pro-active communication of the customer's needs to vendors/retailers in near real-time. It can be a multi-channel interactive network that enables individuals to capture, record, and share information about items they wish to purchase or have purchased for them how, when, and where they wish. It can create a centralized profile that allows customers to organize, manage, and share shopping lists. Customers may use this system to centralize loyalty programs from several retailers and to participate in store-based and manufacturer-sponsored promotion and reward programs.

Thus, embodiments of the invention can add a tremendous amount of value to the consumer shopping experience. Consumers can be provided with the ability to manage their shopping experience across multiple channels: bricks-and-mortar; e-commerce; and m-commerce. Embodiments also can create a sense of community around shopping and allow for information sharing between its consumer members. These shopping communities allow consumers to leverage their buying power with retailers by providing them information about the goods they want.

With reference to retailers, embodiments of the invention can serve as a tool for retailers to converge their bricks-and-mortar venues with their e-commerce initiatives. Retailers can also leverage data across multiple channels for a better marketing and merchandising operation. In addition, embodiments of the invention allow a retailer to have a dialogue with a consumer in a pre-sale environment. Such dialogue can allow a retailer to more effectively engage their customers around specific promotions or discounts. As retailers strive to strengthen their brands and marketing reach, the inherent shopping community and list sharing, allow retailers to tap the hidden capability of viral marketing.

Embodiments of the invention allow consumers to communicate their shopping desires and share those with their sphere of influence (i.e., a ‘friend’ network or Affinity Group), thus passing on the retailers' offers, promotions, and marketing messages at the same time. Such communications can create a de facto viral marketing program and broaden the brand and offering of retailers.

According to embodiments of the present invention, the systems and methods comprise a text/SMS-based communications platform configured to allow a user to access, search, and share product-related information via a keyword-based text/SMS message interface (herein referred to as the “SMS On-Demand Interface”) and related dialogue/functionality (herein referred to as the “SMS On-Demand System”). As used herein, the term “SMS message” is intended to include any conventional text message. The following description relates to an exemplary embodiment of the SMS On-Demand System and SMS Interface according to embodiments of the present invention, and includes exemplary syntax descriptions and workflow examples.

According to embodiments of the present invention, the SMS On-Demand System and SMS On-Demand Interface allows a user to perform one or more of the following commands or tasks, each having a command code associated therewith: search for and identify one or more products; share product, vendor, promotion, and/or retailer information (collectively referred to as “product-related information” with a ‘friend’ (e.g., another mobile device), save product-related information to his or her own records, search and identify one or more promotions and/or media associated with a product or products. As such, the syntax of the SMS Interface is focused on narrowing results to return specific products.

According to an embodiment of the present invention, SMS Interface interactions are implemented as text/SMS messages sent to a central SMS address associated with the SMS On-Demand System (herein referred to as the “On-Demand Address”). The message may comprise a command code and one or more keywords or other text.

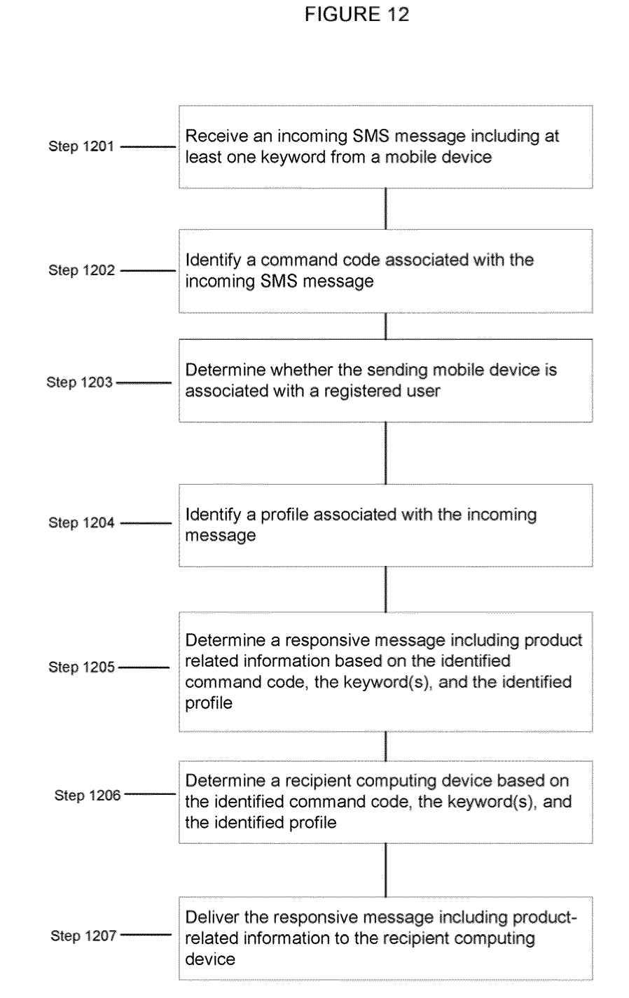

FIG. 12 illustrates an exemplary method for providing on-demand delivery of product-related information in response to a message received from a mobile computing device (e.g, a mobile phone or PDA). As shown in FIG. 12, in step 1201, the SMS On-Demand System receives an incoming SMS message from a mobile device. The incoming SMS message is addressed to the On-Demand address and includes a communication of at least one ‘command code’ such that the SMS On-Demand System may identify a command code associated with the incoming SMS message, as detailed with respect to step 1202. The command code may be explicitly stated in the incoming message, or it may be absent from the incoming message and interpreted by the SMS On-Demand System as a default command code. For example, the incoming message may explicitly include the command code of “SEARCH” or the SMS On-Demand System may be configured to interpret any incoming message including only one or more keywords (i.e., no explicit command code) as a request to perform a default command code which is predetermined. In this regard, for example, the absence of an explicit command code may be interpreted by the SMS On-Demand System as a request to perform a SEARCH in connection with the one or more keywords included in the incoming SMS message.

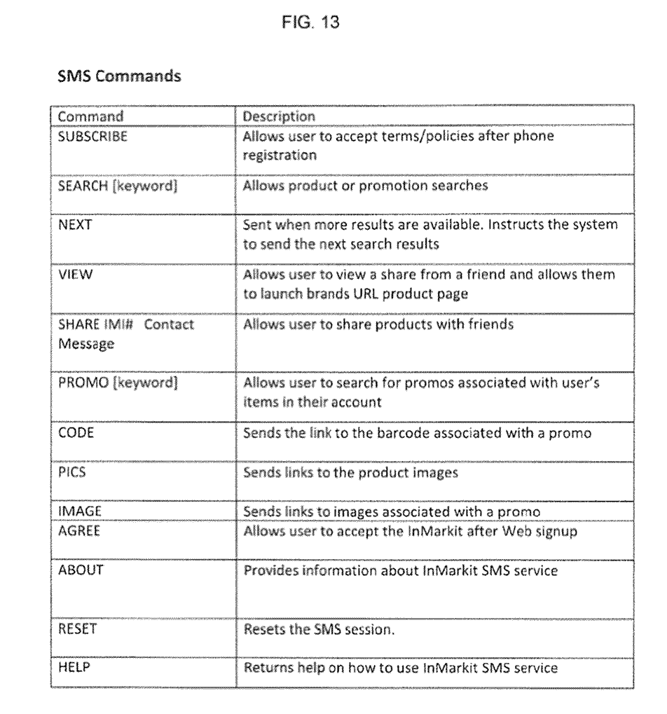

As used herein, the term ‘command code’ refers to a code representing a command or task to be performed by the SMS On-Demand System. Exemplary command codes are detailed below with reference to FIG. 13. The list of command codes set forth in FIG. 13 is not intended to be an exhaustive list of the command codes that may be processed by the SMS On-Demand System, but are provided of the purposes of illustration. One having ordinary skill in the art will appreciate that a command code may comprise any one or more alphanumeric characters (e.g., letters, numbers, symbols, spaces, etc.) in a string and may comprise more than one word, term, phrase, or combination of alphanumeric characters. In operation, a user of the mobile device creates a SMS message comprising: 1) a command code (either an explicit command code or an implicit or default command code) relating to the task/function that the user wishes to have performed by the SMS On-Demand System; and 2) one or more keywords to delimit, govern, modify, and/or provide context to the command code, and addresses or sends the SMS message to the On-Demand Address.

With reference to step 1201, the incoming SMS message received by the SMS On-Demand System comprises one or more ‘keywords.’ As used herein, the term ‘keyword’ refers to a word, a term, a phrase, a name, an alphanumeric sequence, an IMI identifier, or any combination of characters that may be read and processed by the SMS On-Demand System. According to an embodiment of the present invention, the SMS On-Demand System is configured to analyze the command code and the one or more keywords to determine the scope, nature, and deliverable(s)/output(s) associated with the action requested by the incoming SMS message.

According to an embodiment of the present invention, optionally, in step 1203, the SMS On-Demand System determines whether the mobile device from which the SMS message was received is associated with a user profile registered with the SMS On-Demand System. If so, the SMS On-Demand System identifies a registered user profile associated with the incoming SMS message, in step 1204. Optionally, the identified profile may be considered by the SMS On-Demand System in steps 1205 and/or step 1206, as described below.

In step 1205, the SMS On-Demand System determines and formulates a message to be transmitted in response to the incoming SMS message, herein referred to as a ‘responsive message’. The responsive message generated by the SMS On-Demand System includes, but is not limited to, product-related information. The product-related information to be included in the responsive message is determined by the SMS On-Demand System based on the command code associated with the incoming SMS message (i.e., the explicit command code included in the incoming SMS message or a default command code) and the one or more keywords included in the incoming SMS message.

Optionally, the user profile identified in steps 1202 and 1203 may also be utilized by the SMS On-Demand System in determining aspects, format, and/or content (i.e., the product-related information) associated with the responsive message. According to an embodiment of the present invention, the SMS On-Demand System may access and review the user profile associated with the mobile device that sent the incoming SMS message (i.e., the sending mobile device) and consider the information stored in the user profile in the formulation of the responsive message.

In step 1206, the SMS On-Demand System determines a computing device (and corresponding device identification information, such as, for example, a mobile phone number) to receive the responsive message (i.e., the recipient computing device). According to an embodiment of the present invention, the responsive message may be transmitted to more than one recipient computing device. In order to identify the recipient computing device, the SMS On-Demand System reviews the command code, the at least one keyword, the identified user profile, or any combination thereof.

According to an example, the SMS On-Demand System receives an incoming SMS message from a mobile phone having a phone number of 123-456-7890, in step 1201. The incoming SMS message includes the following content “Search Armani”, wherein “Armani” is a keyword. In step 1202, the SMS On-Demand System identifies that the incoming SMS message includes a command code of “Search”.

According to an embodiment of the present invention, the incoming SMS message may include only the keyword of “Armani” and no explicit command code. In this case, the SMS On-Demand System may be configured to interpret the absence of an explicit command code as a request to perform a default command code, such as, for example, a ‘Search’ command code.

Returning to the example above wherein the incoming SMS message includes the “Search Armani” content, in step 1203, the SMS On-Demand System determines whether the originating mobile device is associated with a user registered with the SMS On-Demand System. If the originating mobile device is associated with a registered user, then in step 1204 the system identifies the specific user profile associated with the registered user. According to an embodiment of the present invention, if in step 1203 the system determines that there is no specific registered user profile associated with the originating mobile device, the system identifies the request as originating from a ‘non-registered user’. In this regard, in step 1204, the system 100 identifies and associates a non-registered user profile with the request originated by the non-registered user.

Continuing with the above example, the SMS On-Demand System determines that the mobile device having a phone number of 123-456-7890 is associated with user “John Doe” and identifies John Doe's user profile. Previously, John Doe established his user profile to include, among other product-related information, information relating to a green v-neck sweater sold by Armani. The SMS On-Demand System searches John Doe's user profile based on the ‘Armani’ keyword and identifies information associated with the green V-neck sweater sold by Armani. In step 1205, the responsive message is then formulated to include, but is not limited to, the identified product-related information (i.e., information associated with the Armani green V-neck sweater identified in the user profile). In this regard, the responsive message was based on the command code (Search), the keyword (Armani) and the user profile (i.e., the identification of product-related information associated with Armani as stored in the user profile).

In step 1206, the SMS On-Demand System determines where to send the responsive message by identifying a recipient computing device. The recipient computing device may be determined based on one or more of the following elements: the command code, the at least one keyword, and the identified user profile. Depending on the scope, definition, and/or nature of the command code, the SMS On-Demand System may determine that the originating mobile device is also the recipient computing device. For example, the ‘Search’ command code (without any keywords modifying the recipient) may be interpreted as a request to return the search results to the originating mobile device.

In another example, a ‘Share’ command code (described in detail below) may be viewed in combination with a keyword and/or the user profile to identify a ‘friend’ or contact of the user associated with the originating mobile device as the recipient computing device. In this example, upon receipt of an incoming message including “Share IMI identifier Bob”, the SMS On-Demand System may review the user profile, identify a recipient computing device associated with the a record for “Bob Jones” stored in the user profile, and share or send the responsive message (including product-related information for Armani) to a computing device associated with Bob Jones. Optionally, the incoming SMS message may include a phone number or identifier associated with a particular recipient computing device.

Following a determination of the recipient computing device (i.e., the originating mobile device or another computing device), in step 1207, the SMS On-Demand System delivers the responsive message including the product-related information to the recipient computing device. The responsive message may be delivery in any suitable message format, such as, for example, a SMS message. Furthermore, the delivery of the responsive message may be broken up or distributed over more than one message, in view of, for example, limits placed on message-sizes, as described below with respect to the examples detailed in FIG. 13.

FIG. 13 provides a list of exemplary command codes and related descriptions for use with the SMS On-Demand System, according to embodiments of the present invention.

According to an embodiment of the present invention, the SMS On-Demand System searches an incoming message for a command code as the first text within a message. According to an embodiment of the present invention, a ‘space’ may be used as a delimiter for arguments within a command string. According to an embodiment of the present invention, a ‘comma’ may be used as a delimiter between multiple recipients/targets in a ‘SHARE’ transaction, as described in detail below.

According to an embodiment of the present invention, a search for product-related information may return multiple results. These results are apportioned or split up into separate pages with an appropriate number of results (e.g., four (4) results) displayed on each page. Optionally, in the event a search returns more than a predetermined threshold (e.g., twenty (20) results), the SMS On-Demand System may be configured to return an error message (e.g., a “Too many results” message) and prompt the user to supply addition keywords to narrow the results:

The following sections include descriptions of exemplary command codes and syntax of relating to interactions and messaging between a user and the SMS On-Demand System. One having ordinary skill in the art will appreciate that the command codes described below and shown in FIG. 13 are presented as examples which are intended to illustrate certain functionality of the system, and are not intended to represent an all-inclusive, specific or definitive list of command codes. In the examples described below: 1) command, codes are presented in uppercase text; 2) the [brackets] represent command codes/arguments; and 3) the (braces) indicate optional command codes or arguments.

{SEARCH} [Keyword(s)]

According to an embodiment of the present invention, the incoming message may include the word ‘Search’ in combination with one or more keywords. The system recognizes the SEARCH command code and performs a search based at least on the one or more keywords. According to an embodiment of the present invention, in the event the message does not include a specific command, the ‘SEARCH’ command is the default command code. As such, as illustrated by the use of the {braces}, the ‘SEARCH’ command code is optional. The text following the ‘SEARCH’ command (either explicitly or by default) is assumed to be a search keyword or multiple keywords separated by spaces. According to an embodiment of the present invention, exemplary keywords may include, but are not limited to an IMI, location or place, category, person or any other suitable keyword. According to embodiments of the present invention, keywords are additive and serve to narrow results, and multiple keywords are separated by spaces. The SMS On-Demand System is configured to returns a list of one or more results based upon the search parameters provided by the incoming message from the user. In the event the SMS On-Demand System is unable to find any results in response to the inputted request, a no results message is returned to the requester.

According to an embodiment of the present invention, command codes are identified as reserved words and not read as search parameters, unless preceded by another command code. For example, a message including “SEARCH promo” would trigger the execution of a search using “promo” as a keyword. According to an embodiment of the present invention, any items or products that are searched for using an IMI identifier, or items that are shared to a user, are saved to the user's profile/account, if not previously saved to their account.

SHARE [IMI Identifier] [Person(s)]{Message}

According to an embodiment of the present invention, the ‘SHARE’ command instructs the SMS On-Demand System to share information relating to the product identified by the IMI identifier with the person(s) listed. According to an embodiment of the present invention, multiple intended recipients/contact names are separated by commas. As illustrated by the {braces}, the ‘Message’ text is optional, and may be sent to each recipient along with the corresponding product-related information. The ‘Person(s)’ arguments may comprise any information suitable to identify a recipient and/or the recipient's computing device, including, but not limited to, an e-mail address, mobile phone number, messaging identifier, pin number, or first and/or last name of a user contact (which may be cross-referenced against the user's contact/friend list stored in his or her user profile). According to an embodiment of the present invention, a single character string is used per user contact (e.g. “Bill”, “Jones”, “Mom”).

According to an embodiment of the present invention, invalid e-mail address or phone number format arguments or failure to match a ‘Person’ identifier with a valid user contact may result in an error message for each invalid value. Furthermore, failure to match the IMI identifier to a valid ‘product’ results in the return of an error message. According to an embodiment of the present invention, if multiple matches are identified for a supplied contact name (e.g., ‘John’ is the key provided by a first user and the first user has contacts ‘John Smith’, ‘John Jones’, ‘Frank John’) the SMS On-Demand System sends an SMS message to the user prompting the user to identify the intended recipient. Optionally, a user may respond with ‘ALL’, the number next to the contact, or the numbers for multiple contacts separated by commas. Multiple requests to select ‘users’ are sent in a synchronous manner, to avoid flooding the user with requests. For example, suppose the user submits the following command string “SHARE 67Y8H7 john,frank this is really cool”; and the user has three (3) contacts with the name ‘John’ and two contacts with name ‘Frank’. The SMS On-Demand System first sends a message asking the user to select which of the one or more ‘Johns’ is/are the intended recipient(s) and awaits the user's response and selection. Then, upon receipt of the first selection, the SMS On-Demand System sends a second message asking the user to select which of the one or more ‘Franks’ is/are the intended recipient(s). Upon receipt of the user' response to the second request, the SMS On-Demand System completes the requested transaction.

According to an embodiment of the present invention, sharing an item via the SMS Interface functions similarly to the ‘sharing’ of an item through the consumer web site, in that if you have not already marked the item for yourself, the SMS On-Demand System creates a ‘mark’ record for the user.

NEXT

According to an embodiment of the present invention, the ‘NEXT’ command may be sent by the user as a response to an appropriate message from the SMS On-Demand System, and instructs the SMS On-Demand System to send the next set of information or batch of query rows.

VIEW

According to an embodiment of the present invention, the ‘VIEW’ command may be sent to the SMS On-Demand System as a response to a SHARE notification, and instructs the SMS On-Demand System to send product-related information and details to the requestor's device.

PICS or PIC

According to an embodiment of the present invention, the ‘PIC’ or ‘PICS’ command instructs the SMS On-Demand System to send a link to an image associated with product-related information and/or links to any additional images associated with the product along with a URL identifying a provider's/brand's e-commerce web site.

DONE

According to an embodiment of the present invention, the ‘DONE’ command may be sent as a response to a results list of contacts provided during a SHARE transaction, and instructs the SMS On-Demand System to process additional contact arguments, if any.

PROMO [Keyword(s)]

According to an embodiment of the present invention, the ‘PROMO’ command instructs the SMS On-Demand System to respond with any promotional or campaign information related to the one or more keywords. Exemplary keywords suitable for use in retrieving promotional information include, but are not limited to, a vendor/retailer name, a physical location (i.e., the name of a shopping center, a city, a state, etc.), an IMI identifier for a product or promotion, or any other suitable keyword associated with product-related information.

CODE

According to an embodiment of the present invention, the ‘CODE’ command instructs the SMS On-Demand System to send a link to a URL of a 2D barcode associated with a promotion.

HELP {Command code}

According to an embodiment of the present invention, the ‘HELP’ command returns instructional text in connection with the use or functionality of the supplied command code. According to an embodiment of the present invention, the ‘HELP’ command without the optional specific command code returns a list of command codes and general instructions.

SUBSCRIBE

According to an embodiment of the present invention, the ‘SUBSCRIBE’ command updates a user's profile to accept SMS-based share notifications (i.e., an opt-in instruction).

UNSUBSCRIBE, HALT, STOP, CANCEL and END

According to an embodiment of the present invention, the above-captioned commands each update a user's profile to prevent SMS share notifications, (i.e. opt-out instructions).

AGREE, ACCEPT, YES, Y, OKAY, OK, GO

According to an embodiment of the present invention, the above-captioned commands may be sent as a response to a request for first-time mobile sign up, validate a mobile device number in a user profile, and/or communicate a user's agreement to terms and policies.

RESET

According to an embodiment of the present invention, the ‘RESET’ command resets an SMS session and initializes a session so that user must explicitly provide an IMI identifier for SHARE, and PROMO transactions.

Session Handling & Result Groups

According to an embodiment of the present invention, the SMS On-Demand System identifies a user by the mobile number associated with each message sent to the server. The SMS On-Demand System compares the mobile number with the mobile number of a user record. If no user record exists (for example, with first time use of the SMS On-Demand System) the SMS On-Demand System creates an unregistered user account associated with the mobile number. A user may validate the account by registering on the InMarkit Consumer Web site. Otherwise the user record is maintained until it passes an inactive time limit, when it is removed. Users may be sent a reminder message to register; we may require display of a TOS message on first use (with an AGREE response required)

The SMS server maintains an active session to simulate interaction with the user. When returning results that contain more rows than may be displayed within a common screen size, the SMS On-Demand System displays a subset of results, and allows the user to request more results. Upon receiving a ‘NEXT’ keyword, the SMS On-Demand System returns the next set of results that fit within the screen, and so on with each individual ‘NEXT’, until there are no longer any results to display.

According to an embodiment of the present invention, sessions maintain the IMI identifier for a product, so that the user does not have to enter that value each time a MARK, SHARE or PROMO is executed from a product details message. Optionally, sessions may be set to expire after a predetermined amount of time (e.g., 20 minutes), or when the user sends a ‘RESET’ command.

According to an embodiment of the present invention, each result within a group is labeled with a numeric identifier, beginning with 1. To retrieve product-related information for an individual result, the user sends the numeric identifier to the SMS On-Demand System via the code associated therewith. The SMS On-Demand System responds with the Product associated with the identifier. If the SMS On-Demand System receives a command code or keyword instead of a numeric identifier, the session is reset and the SMS On-Demand System executes the command or performs a search on the keyword.

According to an embodiment of the present invention, if the query results in an unmanageable number of results (for example, a set of greater than 20), the SMS On-Demand System responds with a message asking the user to narrow the search by entering additional keywords. When returning product-related information or other data that exceeds the space for one message, the SMS On-Demand System splits the data into multiple messages. Results groups are usually returned as a single message, but may extend to multiple messages in the case of excessive copy. ‘SHARE’ or ‘PROMO’ command codes sent after receiving product-related information assumes that the command is intended for the current IMI identifier associated with the current session.

According to an embodiment of the present invention, the content of Mobile Terminated SMS messages sent by the SMS On-Demand System may be of a larger size than is supported by a single SMS message. In this case, the response may be split over several messages. Splits may occur at any logical break, but typically words are not split or broken up. Response “fragments” (i.e., the individual messages that make up the entirety of the responsive message) are pre-pended with text that indicates the number of the fragment and the total number of fragments in a responsive message. This text indicator takes the form of “(fragment number/total fragments)”. No space is added between the indicator and message text. For example:

(1/3) This is the first line of the first message of a response with three fragments. Next

(2/3) is the first line of the second message of a response with three fragments

Query Order of Operation & Results Display Order

According to an embodiment of the present invention, the SMS On-Demand System assumes that the user is looking for product-related information, unless a specific command code (‘MARK’, ‘SHARE’, ‘PROMO’, ‘CONTACTS’, ‘HELP’) is used. Optionally, the SMS On-Demand System searches based on multiple fields, but may display result matches in the following order of precedence: 1) Product name 2) Place name 3) Person name 4) Product description.

Error Handling & Action Confirmation

According to an embodiment of the present invention, the SMS On-Demand System is configured to return information (i.e., either the requested information or an appropriate error message) to a user each time a message is received from the user. If an error was encountered, the system returns an appropriate error message, with a reference to HELP. Optionally, the error message may include an example of proper usage of the command code.

If a keyword for a ‘SHARE’ command entered by a user results in ambiguity (e.g. Does “Joe” refer to “Joe Parks” or “Joe Davis” as a recipient?), the SMS On-Demand System returns a list of contacts, allowing the user to select recipient(s) from the results list(s).

If a user provides a response to a results list with an argument that is not contained within a results list (e.g., sending a response of ‘5’ when only 3 results are provided), the SMS On-Demand System responds with an appropriate error message (e.g., “Invalid entry. Try again.”) and reprints the results list message.

According to an embodiment of the present invention, when the SMS On-Demand System is able to complete a ‘MARK’ or ‘SHARE’ transaction, or some other action that does not automatically return a query or other result, the SMS On-Demand System may return a confirmation message indicating that the action was performed. If the SMS On-Demand System is unable to find any results in response to a query, the SMS On-Demand System sends a message indicating this to the user. Optionally, all responsive messages sent by the SMS On-Demand System include a set of common standard footers, containing a confirmation message, or tips on use.

According to an embodiment of the present invention, the SMS On-Demand System is configured to allow a user to search for promotions/campaigns on specific item categories or keywords (e.g., promo buzz shirts). In this regard, according to an embodiment of the present invention, promotions are only returned for those products marked or shared by/with the user.

According to an embodiment of the present invention, interactions with the SMS On-Demand System require a simple implementation with minimal use of delimiters, and no complex command strings. In order to support the use of multiple contacts by name when sharing, space as a delimiter and comments in the same string, contacts by name use only a first or last name. Users may be asked to select from among a list of contacts if a name produces multiple potential addressee targets. Optionally, multiple addressee targets are separated by commas with no spaces, and messages have standard headers and footers following the best practices by other vendors.

Exemplary SMS Messages and Related Workflow

The following are exemplary SMS messages generated by the SMS On-Demand System, according to embodiments of the present invention. According to an embodiment of the present invention, a responsive message may be split into the following three (3) sections (except for smaller messages): 1) Response: This is the part of the message including the requested information; 2) Instructions: This section includes any applicable follow up instructions (e.g., Send, Visit, etc.); and 3) Tip: This section includes any applicable ‘tip’ or other instructional information for the user.

Provided below are example message types, according to embodiments of the present invention.

SMS Share Notification

According to an embodiment of the present invention, the above-captioned message is sent to non-registered users. The message is sent to them prior to agreeing to the terms and conditions associated with the SMS On-Demand System. If the user sends a message to “VIEW” etc., the non-registered user is first prompted to accept the terms and conditions. After the user agrees to terms, the user then receives the requested information. According to an embodiment of the present invention, a ‘SHARE’ message comes to a new user (as shown in the example below), the new user replies with a “VIEW” command, the SMS On-Demand System sends the new user an “accept terms” message. If the new user agrees, the SMS On-Demand System sends the new user a confirm message, followed by a VIEW message in accordance with the new user's request.

### Example

[FirstName FirstInitialLastName] [senders mobile no.], shared
[ProductName] from [PlaceName]
“[ShareMessage]”
Reply VIEW for detail (when View is sent, returned message is 14.5)
Visit [www.merchantsite.com]
Reply STOP to 627548 to halt msgs
Std msg charges apply.

SMS Mobile Number Change Validation

According to an embodiment of the present invention, the SMS On-Demand System is configured to transmit a message after a request to change to a mobile device number associated with a user's profile, and a corresponding message to confirm agreement to the applicable terms and conditions.

You've changed the Mobile # in your InMarkit profile. Reply AGREE to
627548 to validate
Thanks 4 joining InMarkit. Reply STOP to 627548 to halt. Reply HELP
for help/support.
www.inmarkit.com support@inmarkit.com Std msg charges apply

Consumer Web site Registration Mobile Validation

According to an embodiment of the present invention, the SMS On-Demand System is configured to transmit a message to a new user after registration, and a corresponding message in response to the user's acceptance of the applicable terms and conditions.”

Welcome, InMarkit Alerts/Query. www.inmarkit.com Std msg charges
apply. Reply STOP to 627548 to halt. Reply HELP for help. To accept
sign up reply ACCEPT
Thanks 4 joining InMarkit. Reply STOP to 627548 to halt. Reply HELP
for help/support.
www.inmarkit.com support@inmarkit.com Std msg charges apply

Mobile Sign Up

According to an embodiment of the present invention, the SMS On-Demand System is configured to transmit a message to a new user after requesting information regarding an IMI identifier for the first time, receiving a ‘SHARE’ request for the first time, or receiving a command other than ‘STOP’ or ‘HELP’ for the first time. The SMS On-Demand System may send a follow up message in response to the user's entry of a ‘SUBSCRIBE’ command, following by sending an appropriate message in response to the VIEW” message sent by the user.

Welcome, InMarkit Alerts/Query. By using you agree that you are at least
16 years of age and to terms/policies posted at www.inmarkit.com/terms
and www.inmarit.com/privacy. Std msg charges apply. Reply HELP for
help. Reply STOP to halt. Visit www.inmarkit.com for more. To agree to
terms, conditions, policies, and age requirements of InMarkit reply
SUBSCRIBE
You've agreed to SMS from friends on InMarkit. To turn off, reply
STOP to 627548 or edit your profile www.inmarkit.com. Reply HELP to
627548 for help

Consumer Reset Password:

You've requested InMarkit reset your Password
Your login:[MobileNumber]
Your new password:[Password]
www.inmarkit.com

SMS First Time Auto-registration (also response if tries to send anything else before replying with SUBSCRIBE) same process as the ‘Mobile Sign Up’ messaging described above

Welcome, InMarkit Alerts/Query. By using you agree that you are at least
16 years of age and to terms/policies posted at www.inmarkit.com/terms
and www.inmarkit.com/privacy. Std msg charges apply. Reply HELP for
help. Reply STOP to halt. Visit www.inmarkit.com for more. To agree to
terms, conditions, policies, and age requirements of InMarkit reply
SUBSCRIBE

SMS Auto-registration response (see ‘Mobile Sign Up’ messaging described above)

You've agreed to SMS from friends on InMarkit. To turn off, reply STOP
to 627548 or edit your profile www.inmarkit.com. Reply HELP to 627548
for help

SMS Opt-out response: (to STOP, UNSUBSCRIBE, CANCEL, END, HALT)

You've halted SMS msgs from friends on InMarkit. Send SUBSCRIBE to
627548 to restart msgs or edit your profile at www.inmarkit.com Reply
HELP to 627548 for help/support support@inmarkit.com 800-280-9604

SMS Opt-in response: (to SUBSCRIBE)

You've agreed to SMS from friends on InMarkit. To turn off, reply STOP
to 627548 or edit your profile www.inmarkit.com. Reply HELP to 627548
for help

SMS Error: Error with COMMAND

Sorry, [command] did not return any results.
For Help/Support on InMarkit SMS, reply HELP to 627548
www.inmarkit.com

SMS SHARE

According to an embodiment of the present invention, the SMS On-Demand System is configured to send this message when a registered user ‘SHARES’ an item with others. Registered users can share to a mobile number if they are registered users with their first and last name in their user profile. The “message” text is optional. If multiple matches are found for a contact name, the system sends an SMS message to request that the user identify which contact to share with. When a user is done selecting contacts for a name keyword, they respond with a ‘DONE’ command. According to an embodiment of the present invention, no IMI identifier is required in a ‘SHARE’ message when the ‘SHARE’ command is sent as part of a “session”

SHARE [IMI #] [mobile number, email or first or last name] [msg]
(if multiple contacts with same name are found the following is returned)
Found multiple contacts
1 ‘first name’ ‘last name’
2 ‘first name’ ‘last name’
3 ‘first name’ ‘last name’
Reply 1 to 3 or Next for more
Reply DONE to finish

### Successful Share Response

(if successful)
You've shared [ProductName] from [PlaceName] with [Contact , ] (only
use comma if multiple contacts)
Visit [www.merchantsite.com]

SMS Promo

Promo:[PromotionSMSName], from[PlaceName]
[PromotionSMSDescription]
Reply CODE for barcode
Visit [URL to merchant site]

SMS No Promo Found

Sorry, ‘[keyword]’ did not return any promos
Reply PROMO keyword(s) for promos

SMS Product Detail

According to an embodiment of the present invention, the SMS On-Demand System is configured to send a message when a user responds to multiple item selection from a search. For example, a user reply of ‘1’ represents the product detail message that is returned to the SMS On-Demand System. This message is sent in response to a user sending a request on an item ex: reply 1 to 3, user reply 2 and gets this message with that product detail

(results display share direction and user full name if share; nothing if
mark)
[ProductName],from[MerchantName] [to .or. from][FirstName or email]
“[Mark/Share Comment]”
[ProductDescription]
Reply PICS
Reply PROMO (if promotion(s) for product)
Reply SHARE and a first or last name, or ph # or email
Visit [www.merchantsite.com]

SMS Response to ‘VIEW’ command from a ‘SHARE/SEARCH session for an IMI identifier, if that IMI identifier is not already part of the user profile

According to an embodiment of the present invention, the SMS On-Demand System is configured to send a message to the user in response to a ‘VIEW’ command, a ‘SHARE’ command, or a ‘SEARCH’ command relating to an IMI identifier that is not already part of the user's profile.

[ProductName], from[MerchantName]
[URL link to brand's product landing page]
Reply PICS
Reply PROMO (if promotion(s) for product)
Reply SHARE and a first or last name, or ph # or email
Visit [www.merchantsite.com]

SMS No Match for a Keyword is identified

Sorry, ‘[keyword]’ did not return any items
Reply with search keyword(s) to find items
Reply HELP for help

SMS Image Files for Product: (always available, shows first product image)

PICS:[ProductName], from [MerchantName]
Click: [URL] (on first results message, first link is always primary product
image file, with “Item Image” as label. Additional images are formatted
[Description]: [URL]. (Note: there must be a blank space between the :
and the [url] in order for the url to be an active link)
Click: [URL]
Reply NEXT for more (if more than 2 image files)
Visit [www.merchantsite.com]

SMS Barcode Files for Promo

Code:[PromotionName], from [MerchantName]
Click: [URL]
Visit [www.merchantsite.com]

SMS Promo Results List: (if single result, direct display details message)

Promo:[search parameter(s) used]
(for each result, max 3 per message)
[result #] [ProductName], [Place] (repeats as necessary for multiple
results)
(if more than one page of results; only display “or NEXT...” if additional
results pages)
Reply [# first result for page] to [# last result for page] for detail or NEXT
for more
(if single page of results)
Reply 1 to [# of results] for detail

SMS Product Results List: (if single result, directly display details message, if multiple results returned once selected is entered the SMS On-Demand System returns the “SMS Product Detail” message, described above

Search:[search parameter(s) used]
(for each result, max 3 per message)
(results display share direction and user first name if share; nothing if
mark)
[result #] [ProductName], Place [to .or. from] [FirstName ] (repeats as
necessary for multiple results)
(if more than one page of results; only display “or NEXT...” if additional
results pages)
Reply [# first result for page] to [# last result for page] for detail or NEXT
for more
(if single page of results)
Reply 1 to [# of results] for detail (return “SMS Product Detail” message)

SMS Validation Confirmation

Thanks 4 joining InMarkit. Send STOP to 627548 to halt. Send HELP for
help/support.
www.inmarkit.com support@inmarkit.com Std msg charges apply

SMS Help Text: responses for HELP [command] and general HELP example: Help About

(ABOUT)
ABOUT
InMarkit lets you bookmark, add to your wish list and comment on a
product whenever & wherever.
Tip: Reply HELP for commands
(SEARCH)
SEARCH keyword(s)
SEARCH and a keyword(s) separated by space.
Tip: Reply HELP for commands
(RESET)
RESET
Resets the SMS session.
Tip: Reply HELP for commands
(SHARE)
SHARE IMI# Contact, Message
SHARE an IMI product with Contact(s) Separate multiple contacts, with
commas. Share to a mobile, email, or the first or last name of an InMarkit
contact. Message is optional
Tip: Reply HELP for commands
(DONE)
DONE
When selecting contacts for SHARE, Done instructs system to finish
Tip: Reply HELP for commands
(AGREE)
AGREE, ACCEPT, YES, Y, OKAY, OK, GO
Acknowledges you accept the terms/policies and that you are at least
16 years of age. A full description of terms/policies may be found at
www.inmarkit.com
Tip: Reply HELP for commands
(VIEW)
VIEW
Lets you see your product
Tip: Reply HELP for commands
(NEXT)
NEXT
Lets you see your next items
Tip: Reply HELP for commands
(PROMO)
PROMO keyword(s)
PROMO lets you find promos on your items
Tip: Reply HELP for commands
(PICS)
PICS
Sends links to the product images
Tip: Reply HELP for commands
(CODE)
CODE
Sends a link for scannable barcode
Tip: Reply HELP for commands
HELP returns instructions for the use of a Command code. SEE ABOVE
HELP without a Command code returns InMarkit contact information and
a list of commands and examples
(response for HELP without command)
InMarkit Queries/Alerts www.inmarkit.com support@inmarkit.com
800-280-9604 Std msg charges apply. Reply STOP to halt.
Text commands to 627548 for results.
Ex:
SEARCH t-shirt
SHARE imi # john this is my msg
PROMO imi #
CODE imi #
PICS imi #
VIEW
RESET
ABOUT
Reply HELP Command for help with command Ex. HELP SHARE

### Invalid SMS IMI Response

(if the IMI identifier is invalid)
Sorry, ‘[IMI#]’ did not return any items
Reply with search keyword(s) to find items
Reply HELP for help
(There is no MARK in the SMS format. When a person requests an IMI#,
if the IMI number has not been previously saved for this person, it is
automatically saved)

Invalid SMS Share Response

(if the IMI identifier is invalid)
Sorry, ‘[IMI#]’ did not return any items
Reply with search keyword(s) to find items
Reply HELP for help
(if all contacts by name were invalid)
Sorry, ‘[contact]’ did not return any contacts
Reply HELP for help
(if user has not registered with a first and last name prior)
Sorry we can't share [product name] with. [mobile number]
until you've registered at InMarkit. Please visit www.InMarkit.com to
register.

SMS Share Message from User Share

According to an embodiment of the present invention, the SMS On-Demand System sends the following message to a registered user (either a SMS-registered or web-registered user)

[FirstName FirstInitialLastName] [senders mobile no.], shared
[ProductName] from [PlaceName]. “[ShareMessage]”
Reply VIEW for detail (when View is sent, returned message is 14.5)
Visit [www.merchantsite.com]
Std msg charges apply.

Although embodiments of the invention have been described in considerable detail with reference to certain preferred embodiments and versions, other versions and embodiments are readily implemented by those of skill in the art. Therefore, the scope of the appended claims should not be limited to the description of the version and embodiments expressly disclosed herein.

What is claimed is:

1. A method for providing on-demand delivery of product-related information, the method comprising the steps of:
receiving an incoming SMS message comprising at least one keyword from a mobile device;
identifying a command code associated with the incoming SMS message;
identifying a profile associated with the mobile device based at least on the incoming SMS message,
determining a responsive message comprising product-related information based on the identified command code, the at least one keyword, and the identified profile; and
delivering the responsive message to a recipient computing device identified based on the command code, the at least one keyword, and the identified profile.

2. The method of claim 1, wherein the at least one keyword comprises an identifier associated with the recipient computing device.

3. The method of claim 1, wherein the at least one keyword comprises an IMI identifier.

4. The method of claim 1, wherein the responsive message further comprises a web-based link to additional product-related information.

5. The method of claim 1, wherein the recipient computing device comprises the mobile device associated with the user.

6. The method of claim 1, wherein the recipient computing device comprises a mobile device associated with a third party.

7. The method of claim 1, wherein the profile associated with the user comprises at least one of: a user wishlist, a user contact/friend list, user-identified product-related information, a contact/friend wishlist, and contact/friend-identified product-related information.

8. The method of claim 1, wherein the profile associated with the user comprises a user contact/friend list.

9. The method of claim 1, wherein the command code comprises an instruction to identify product-related information associated with a wishlist.

10. The method of claim 1, wherein the command code comprises an instruction to share product-related information identified by the one or more keywords with the recipient computing device.

11. The method of claim 1, wherein the command code comprises an additional instruction to store the product-related information with the profile associated with the user.

12. The method of claim 1, wherein a default command code is identified based on the incoming SMS message.

13. The method of claim 1, wherein the product-related information comprises multimedia.

14. The method of claim 1, wherein the product-related information comprises a barcode.

15. The method of claim 1, wherein the product-related information comprises a code associated with a promotion.
